(19) United States
(12) Patent Application Publication
(10) Pub. No.: US 2018/0220412 A1
(43) Pub. Date: Aug. 2, 2018

(54) PUCCH REGION DETERMINATION AND USAGE FOR MTC

(71) Applicant: Nokia Solutions and Networks Oy, Espoo (FI)

(72) Inventors: Yuantao Zhang, Beijing (CN); Chunhai Yao, Beijing (CN); Rapeepat Ratasuk, Hoffman Estates, IL (US)

(21) Appl. No.: 15/747,883

(22) PCT Filed: Aug. 12, 2015
(86) PCT No.: PCT/CN2015/086787

§ 371 Date: Jan. 26, 2018

(51) Int. Cl. H04W 72/04

(52) U.S. Cl. CPC H04W 72/0413; H04W 72/0446

(57) ABSTRACT

A method includes allocating only a single PUCCH region in each subframe of multiple subframes to be used by UEs for uplink control information transmission. Information is signaled, where the information is defined to configure a UE that is equipped for machine type communication to be able to determine PUCCH regions to be used for uplink control information transmission for data received at the UE. The uplink control information is received, over the plurality of subframes, from the UE in the single PUCCH region per subframe. A UE that is configured for machine type communication receives the signaled information and determines, using the signaled information, a single PUCCH region to use for each subframe to transmit the uplink control information for received data and transmits, over the multiple subframes, the uplink control information from in the determined single PUCCH region per subframe. Apparatus, software, and computer program products are also disclosed.

### TECHNICAL FIELD

This invention relates generally to wireless communication and, more specifically, relates to machine type communication (MTC).

### BACKGROUND

This section is intended to provide a background or context to the invention disclosed below. The description herein may include concepts that could be pursued, but are not necessarily ones that have been previously conceived, implemented or described. Therefore, unless otherwise explicitly indicated herein, what is described in this section is not prior art to the description in this application and is not admitted to be prior art by inclusion in this section. Abbreviations that may be found in the specification and/or the drawing figures are defined below, prior to the claims.

In a typical wireless system, such as a cellular system, UEs that support machine type communications are becoming more prevalent. An MTC device is a UE equipped for machine type communication. The UE communicates through a PLMN with MTC server(s) and/or other MTC device(s). See 3GPP TS 22.368 V13.1.0 (2014-12). MTC devices have a wide variety of applications, such as security (e.g., surveillance systems), tracing and tracking (e.g., fleet management, asset tracking), payment (e.g., point of sale devices), and remote maintenance or control (e.g., sensors, pumps, lights). These devices also have unique communication requirements, as compared to a “typical” cellular device such as a phone or smartphone. For instance, they may transmit information at seemingly random times, at any time of the day, and every day of the week. On the other hand, the amount of information transmitted may be small relative to what is typically used (such as video) by smartphones.

In order to address these issues, improvements in communication techniques for MTC devices are being proposed. For instance, 3GPP LTE has approved a new Rel. 13 work item of further LTE physical layer enhancements for MTC. A Rel. 13 MTC UE only needs to support 1.4 MHz (i.e., only six PRB pairs) RF bandwidth in downlink and uplink within any system bandwidth. The Rel. 13 MTC study targets to specify techniques that can achieve 15-20 dB coverage improvement for FDD, for the use cases where MTC devices are deployed in challenging locations, e.g., deep inside buildings. These techniques may include but are not limited to, e.g., subframe bundling techniques with HARQ for physical data channels, resource allocation using MPDCCH with cross-subframe scheduling with repetition and so on. The amount of coverage enhancement should be configured per cell and/or per UE and/or per channel and/or group of channels.

For MTC devices, most of the time, transferring real-time information is not required. Instead, battery consumption is more crucial, since many devices will be powered by batteries or solar cells that will rarely be recharged. Thus, the Rel. 13 MTC study also targets to provide power consumption reduction schemes, both in normal coverage and enhanced coverage, to target ultra-long battery life.

These types of considerations mean that MTC communication techniques can be improved.

### SUMMARY

This section contains examples of possible implementations and is not meant to be limiting.

One example (example 1) is a first method comprising: allocating only a single physical uplink control channel region in each subframe of a plurality of subframes to be used by user equipments for uplink control information transmission; signaling information defined to configure a user equipment that is equipped for machine type communication to be able to determine physical uplink control channel regions to be used for uplink control information transmission for data received at the user equipment; and receiving, over the plurality of subframes, the uplink control information from the user equipment in the single physical uplink control channel region per subframe.

Another example (example 2) is a second method comprising receiving, at a user equipment that is equipped for machine type communication, signaling comprising information defined to configure the user equipment to be able to determine physical uplink control channel regions to be used for transmitting uplink control information for received data. Only a single physical uplink control channel region is to be used to transmit the uplink control information in each subframe of a plurality of subframes. The method comprises determining, using the signaled information, a single physical uplink control channel region to use for each subframe to transmit the uplink control information for received data, and transmitting, over the plurality of subframes, the uplink control information from the user equipment in the determined single physical uplink control channel region per subframe.

Another example (example 3) is the method of the first or second methods, wherein configuration based on the signaled information is specific to a cell or is specific to a single user equipment. The method of this paragraph is another example (example 4), wherein the signaling uses broadcasting signaling in a system information block in response to the information being cell-specific, or the signaling is sent in a random access response message during initial access of a network by the user equipment in response to the information being user equipment-specific.

A method as above is another example (example 5), wherein the signaled information enables the user equipment to determine one of a plurality of configured physical uplink channel control channel regions to use for each of the subframes for one or more frames. The method of this paragraph is a further example (example 6), wherein the signaled information comprises a starting subframe for the one configured physical uplink channel control channel region and/or a number of subframes to be used for the one specific physical uplink channel control channel region, and wherein the user equipment is expected to determine a starting subframe and/or a number of subframes to be used for other ones of the configured physical uplink control channel regions.

An additional example (example 7) is the method of the previous paragraph, wherein the information comprises one or more of the following: a configured subframe offset between a first configured physical uplink control channel region and a reference subframe; a system frame number of a subframe for a physical uplink control channel transmission; a number of consecutive physical control channel subframes in each configured physical uplink control channel region; a subframe index of a subframe for the physical uplink control channel transmission; and/or a number of the configured physical uplink control channel regions.

A further example (example 8) is the method of the previous paragraph, where the signaled information is defined according to the following:

$${I}_{PUCCH\_region} = mod \{ ⌊ \frac{( SFN * 10 - {N}_{offset} ) + {I}_{subframe} + 1}{X + 1} ⌋ , {N}_{PUCCH\_region} \} ,$$

where: I_{PUCCH}_{_}_{region} is the configured physical uplink control channel region for each physical uplink control channel subframe, 0≤I_{PUCCH}_{_}_{region}≤N_{PUCCH}_{_}_{region}−1; N_{offset} is the configured subframe offset of a first configured physical uplink control channel region relative to subframe number zero in system frame number zero, N_{offset}>=0; SFN_{PUCCH} is the system frame number of the subframe for the physical uplink control channel transmission; X is the number of consecutive physical uplink control channel subframes in each configured physical uplink control channel region; I_{subframe} is the subframe index of the subframe for the physical uplink control channel transmission: for system frame number zero, N_{offset}≤I_{subframe}≤9, and for system frame number greater than zero, 0≤I_{subframe}≤9; and N_{PUCCH}_{_}_{region} is the number of configured physical uplink control channel regions.

A further example (example 9) is a method as above in examples 1-4, wherein the signaled information enables the user equipment to determine a starting region of a plurality of configured physical uplink channel control channel regions to use for each of the subframes for a frame and also to determine a starting subframe within the starting region.

Another example (example 10) is the method of the previous paragraph, wherein the signaled information comprises one or more of the following: a configured subframe offset between a first configured physical uplink control channel region and a reference subframe; a system frame number of a first subframe for a physical uplink control channel transmission; a number of consecutive physical control channel subframes in each configured physical uplink control channel region; a subframe index of the first subframe for physical uplink control channel transmission; and/or a number of the configured physical uplink control channel regions.

The method of the previous paragraph is a further example (example 11), wherein the physical uplink control channel starting region is defined according to the following:

$${I}_{Starting\_PUCCH \_region} = mod \{ ⌊ \frac{\begin{matrix}( {SFN}_{Starting\_PUCCH \_subframe} * 10 - {N}_{offset} ) + \\ {I}_{starting\_subframe} + 1\end{matrix}}{X + 1} ⌋ , {N}_{PUCCH\_region} \}$$

where: I_{Starting}_{_}_{PUCCH}_{_}_{region} is the starting physical uplink control channel region, 0≤I_{Starting}_{_}_{PUCCH}_{_}_{region}≤N_{PUCCH}_{_}_{region}−1; N_{offset} is the configured subframe offset of a first configured physical uplink control channel region relative to subframe number zero in system frame number zero, N_{offset}>=0; SFN_{Starting}_{_}_{PUCCH}_{_}_{subframe} is the system frame number of the starting physical uplink control channel subframe; X is the number of consecutive physical uplink control channel subframes in each configured physical uplink control channel region; I_{starting}_{_}_{subframe} is the subframe index of the first subframe for the physical uplink control channel transmission: for system frame number zero, N_{offset}≤I_{starting}_{_}_{subframe}≤9, and for system frame number greater than zero, 0≤I_{starting}_{_}_{subframe}≤9; and N_{PUCCH}_{_}_{region} is the number of configured physical uplink control channel regions; where the starting subframe for physical uplink control channel transmission within the starting physical uplink control channel region is defined according to the following: I′_{Starting}_{_}_{PUCCH}_{_}_{subframe}=mod{[(SFN_{Starting}_{_}_{PUCCH}_{_}_{subframe}*10−N_{offset})+I_{starting}_{_}_{subframe}],X}, where: I′_{Starting}_{_}_{PUCCH}_{_}_{subframe} is the starting subframe within the starting physical uplink control channel region, 0≤I′_{Starting}_{_}_{PUCCH}_{_}_{subframe}≤X−1; N_{offset} is the configured subframe offset of the first physical uplink control channel region relative to subframe number zero in system frame number zero; SFN_{Starting}_{_}_{PUCCH}_{_}_{subframe} is the system frame number of the starting physical uplink control channel subframe; I_{starting}_{_}_{subframe} is the subframe index of the first subframe for physical uplink control channel transmission: for system frame number zero, N_{offset}—I_{subframe}≤9; and for system frame number greater than zero, 0≤I_{subframe}≤9; and X is the number of consecutive physical uplink control channel subframes in each region.

A method as above is yet another example (example 12), wherein the signaled information also comprises one or more indications of subframes to be used for hopping and not for uplink control information for the user equipment. The method of this paragraph is an example (example 13), wherein at least one of the subframes used for hopping is user equipment-specific and the signaling comprises signaling one or more indications of the user equipment-specific hopping subframe to the user equipment and signaling one or more indications of other user equipment-specific hopping subframes to other user equipments.

Another example (example 14) is a method of any of the examples 2 to 11, wherein if the physical uplink control channel regions of two consecutive physical uplink control channel subframes are different, physical uplink control channel is not transmitted by the user equipment in the first subframe of the two consecutive physical uplink control channel subframes, and the first subframe is used for hopping by the user equipment. See, e.g., FIG. 8.

A further example (example 15) is a method of any of examples 2 to 11, wherein if the physical uplink control channel regions of two consecutive physical uplink control channel subframes are different, physical uplink control channel is transmitted by the user equipment in the first subframe of the two consecutive physical uplink control channel subframes, and the second subframe is used for hopping by the user equipment. See, e.g., FIG. 8.

An additional example (example 16) is a method of any of examples 1 or 3 to 15, further comprising, prior to receiving, transmitting the data to the user equipment, wherein the uplink control information is in response to the data that was transmitted to the user equipment.

An additional example (example 17) is a method of any of examples 1 or 3 to 15, wherein: the signaling information is performed for first and second user equipments, and wherein the signaling information for the first and second user equipments is defined so that both the first and second user equipments use at least one same subframe in at least one same physical uplink control channel region to send uplink control information; and receiving further comprises receiving the uplink control information from the first and second user equipments in the at least one same subframe in the at least one same physical uplink control channel region.

Another example (example 18) is a method of any of examples 2 to 15, further comprising, prior to receiving, transmitting the data to the user equipment, wherein the uplink control information is in response to the data that was transmitted to the user equipment.

Another example (example 19) is a computer program comprising program code for executing the method according to any of examples 1-18. The computer program according to this paragraph (example 20), wherein the computer program is a computer program product comprising a computer-readable medium bearing computer program code embodied therein for use with a computer.

An additional example (example 21) is an apparatus comprising means adapted to perform the method of claims any of the methods 1 or 3 to 17. For instance, the apparatus may comprise: means for allocating only a single physical uplink control channel region in each subframe of a plurality of subframes to be used by user equipments for uplink control information transmission; means for signaling information defined to configure a user equipment that is equipped for machine type communication to be able to determine physical uplink control channel regions to be used for uplink control information transmission for data received at the user equipment; and means for receiving, over the plurality of subframes, the uplink control information from the user equipment in the single physical uplink control channel region per subframe. A base station (example 22) may comprise any of the apparatus of this paragraph.

A further example (example 23) is an apparatus comprising means adapted to perform the method of claims any of examples 2-15 or 18. A user equipment (example 24) may comprise any of the apparatus of this paragraph.

A mobile communication system may comprise any of the apparatus of examples 21 or 22 and any of the apparatus of examples 23 or 24.

An exemplary apparatus includes one or more processors and one or more memories including computer program code. The one or more memories and the computer program code are configured to, with the one or more processors, cause the apparatus to perform at least the following: allocating only a single physical uplink control channel region in each subframe of a plurality of subframes to be used by user equipments for uplink control information transmission; signaling information defined to configure a user equipment that is equipped for machine type communication to be able to determine physical uplink control channel regions to be used for uplink control information transmission for data received at the user equipment; and receiving, over the plurality of subframes, the uplink control information from the user equipment in the single physical uplink control channel region per subframe.

An exemplary computer program product includes a computer-readable storage medium bearing computer program code embodied therein for use with a computer. The computer program code includes: code for allocating only a single physical uplink control channel region in each subframe of a plurality of subframes to be used by user equipments for uplink control information transmission; code for signaling information defined to configure a user equipment that is equipped for machine type communication to be able to determine physical uplink control channel regions to be used for uplink control information transmission for data received at the user equipment; and code for receiving, over the plurality of subframes, the uplink control information from the user equipment in the single physical uplink control channel region per subframe.

An exemplary apparatus includes one or more processors and one or more memories including computer program code. The one or more memories and the computer program code are configured to, with the one or more processors, cause the apparatus to perform at least the following: receiving, at a user equipment that is equipped for machine type communication, signaling comprising information defined to configure the user equipment to be able to determine physical uplink control channel regions to be used for transmitting uplink control information for received data, wherein only a single physical uplink control channel region is to be used to transmit the uplink control information in each subframe of a plurality of subframes; determining, using the signaled information, a single physical uplink control channel region to use for each subframe to transmit the uplink control information for received data; and transmitting, over the plurality of subframes, the uplink control information from the user equipment in the determined single physical uplink control channel region per subframe.

An exemplary computer program product includes a computer-readable storage medium bearing computer program code embodied therein for use with a computer. The computer program code includes: code for receiving, at a user equipment that is equipped for machine type communication, signaling comprising information defined to configure the user equipment to be able to determine physical uplink control channel regions to be used for transmitting uplink control information for received data, wherein only a single physical uplink control channel region is to be used to transmit the uplink control information in each subframe of a plurality of subframes; code for determining, using the signaled information, a single physical uplink control channel region to use for each subframe to transmit the uplink control information for received data; and code for transmitting, over the plurality of subframes, the uplink control information from the user equipment in the determined single physical uplink control channel region per subframe.

### BRIEF DESCRIPTION OF THE DRAWINGS

In the attached Drawing Figures:

FIG. 1 is a block diagram of an exemplary system in which the exemplary embodiments may be practiced;

FIG. 2 illustrates transmission of ACK/NACK in one slot using PUCCH format 1a/1b;

FIG. 3 illustrates two PUCCH regions existing in a same set of subframes;

FIG. 4 illustrates an example of subframe allocation in each PUCCH region in accordance with an exemplary embodiment;

FIG. 5 is a logic flow diagram performed by a network node for PUCCH region determination and usage for MTC, and illustrates the operation of an exemplary method, a result of execution of computer program instructions embodied on a computer readable memory, functions performed by logic implemented in hardware, and/or interconnected means for performing functions in accordance with exemplary embodiments;

FIG. 6 is a logic flow diagram performed by an MTC UE for PUCCH region determination and usage for MTC, and illustrates the operation of an exemplary method, a result of execution of computer program instructions embodied on a computer readable memory, functions performed by logic implemented in hardware, and/or interconnected means for performing functions in accordance with exemplary embodiments;

FIG. 7 is a table illustrating the starting region for each subframe in SFN 2 in an exemplary embodiment; and

FIG. 8 is an illustration of UE-specific hopping subframes in accordance with an exemplary embodiment.

### DETAILED DESCRIPTION OF THE DRAWINGS

The word “exemplary” is used herein to mean “serving as an example, instance, or illustration.” Any embodiment described herein as “exemplary” is not necessarily to be construed as preferred or advantageous over other embodiments. All of the embodiments described in this Detailed Description are exemplary embodiments provided to enable persons skilled in the art to make or use the invention and not to limit the scope of the invention which is defined by the claims.

The exemplary embodiments herein describe techniques for PUCCH region determination and usage for MTC. Additional description of these techniques is presented after a system into which the exemplary embodiments may be used is described.

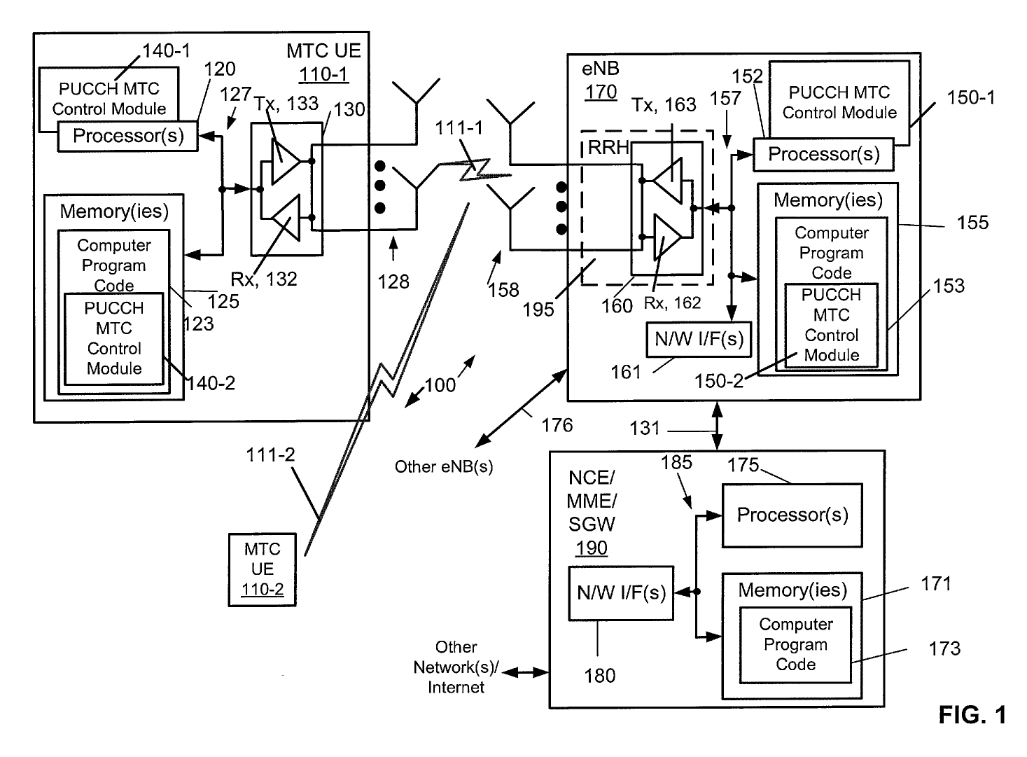

Turning to FIG. 1, this figure shows a block diagram of an exemplary system in which the exemplary embodiments may be practiced. In FIG. 1, MTC UEs 110-1 and 110-2 are in wireless communication with a wireless network 100 (e.g., a mobile communication system). It is assumed the UEs 110 are similar, so here only one UE will be described. Each of the UEs 110 is equipped for machine type communication. Note that other, non-MTC UEs may access the eNB 170, but these non-MTC UEs are not shown. The user equipment 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a PUCCH MTC control module 140, comprising one of or both parts 140-1 and/or 140-2, which may be implemented in a number of ways. The PUCCH MTC control module 140 may be implemented in hardware as PUCCH MTC control module 140-1, such as being implemented as part of the one or more processors 120. The PUCCH MTC control module 140-1 may be implemented also as an integrated circuit or through other hardware such as a programmable gate array. In another example, the PUCCH MTC control module 140 may be implemented as PUCCH MTC control module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UEs 110-1 and 110-2 communicate with eNB 170 via wireless links 111-1 and 111-2, respectively.

The eNB 170 is a base station that provides access by wireless devices such as the UE 110 to the wireless network 100. The eNB 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The eNB 170 includes a PUCCH MTC control module 150, comprising one of or both parts 150-1 and/or 150-2, which may be implemented in a number of ways. The PUCCH MTC control module 150 may be implemented in hardware as PUCCH MTC control module 150-1, such as being implemented as part of the one or more processors 152. The PUCCH MTC control module 150-1 may be implemented also as an integrated circuit or through other hardware such as a programmable gate array. In another example, the PUCCH MTC control module 150 may be implemented as PUCCH MTC control module 150-2, which is implemented as computer program code 153 and is executed by the one or more processors 152. For instance, the one or more memories 155 and the computer program code 153 are configured to, with the one or more processors 152, cause the eNB 170 to perform one or more of the operations as described herein. The one or more network interfaces 161 communicate over a network such as via the links 176 and 131. Two or more eNBs 170 communicate using, e.g., link 176. The link 176 may be wired or wireless or both and may implement, e.g., an X2 interface.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195, with the other elements of the eNB 170 being physically in a different location from the RRH, and the one or more buses 157 could be implemented in part as fiber optic cable to connect the other elements of the eNB 170 to the RRH 195.

The wireless network 100 may include a network control element (NCE) 190 that may include MME/SGW functionality, and which provides connectivity with a further network, such as a telephone network and/or a data communications network (e.g., the Internet). The eNB 170 is coupled via a link 131 to the NCE 190. The link 131 may be implemented as, e.g., an S1 interface. The NCE 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the NCE 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples.

In general, the various embodiments of the user equipment 110 can include, but are not limited to, cellular or other wireless devices such as smart phones, cellular or other wireless devices for surveillance systems, control of physical access to areas, fleet management, order management, asset tracking, traffic information, road tolling, payment systems, health monitoring, metering (e.g., for grid control or power monitoring), or remote maintenance and control, and devices or terminals that incorporate combinations of such functions.

As described above, machine type communications are still being studied and the standards for these communications are being changed. For instance, regarding physical uplink control channel (PUCCH) for MTC, according to RAN1 #81 chairman notes, it was agreed on the following.

For Rel-13 low complexity MTC UEs and UEs operating coverage enhancement for PUCCH are as follows. Both slots in a subframe are used for transmission of a PUCCH. That is, at least for system BW>6RBs, slot-based hopping (e.g., within a narrow band and within a subframe) is not supported. Additionally, the MTC SIB indicates at least two PUCCH narrow band regions for MTC, and it is FFS whether or not the indication is per CE level or the same for all CE levels. The PRBs for the PUCCH resources for Rel-13 low complexity UEs are configured separately from legacy PUCCH. The multiplexing between PUCCH resources in the same PRB for Rel-13 low complexity UEs and legacy UEs is not prohibited.

Operating coverage enhancement for PUCCH is as follows. PUCCH frequency hopping is always used and hopping is between at least two PUCCH narrow band regions. PUCCH frequency location for Rel-13 low complexity UEs in enhanced coverage stays the same for at least X subframes, and the value of X is FFS. It is also FFS whether or not slot-level hopping across narrow bands is supported. If slot-level hopping is supported, the PUCCH frequency location refers to that of a given slot. It is FFS as to how to determine PUCCH repetition resources for Msg4 feedback.

Regarding the information carried in PUCCH, according to RAN1#80bis chairman notes, it was agreed on the following.

For low complexity MTC UEs in normal coverage, at least when PUCCH resource is configured, ACK/NACK and SR over PUCCH is supported. Periodic CSI feedback over PUCCH is supported, although it is FFS on the details of this.

For UEs operating in enhanced coverage, at least when the PUCCH resource is configured, the following were agreed upon. HARQ-ACK and SR over PUCCH is supported. It is FFS as to whether ACK only is transmitted or NACK only is transmitted or both ACK/NACK are transmitted.

RAN1#80 also agreed on the following. Consider simplified channel feedback for MTC power savings at least for coverage enhanced MTC UEs. There is no support of periodic CSI measurement and feedback for UEs in need of large coverage enhancement.

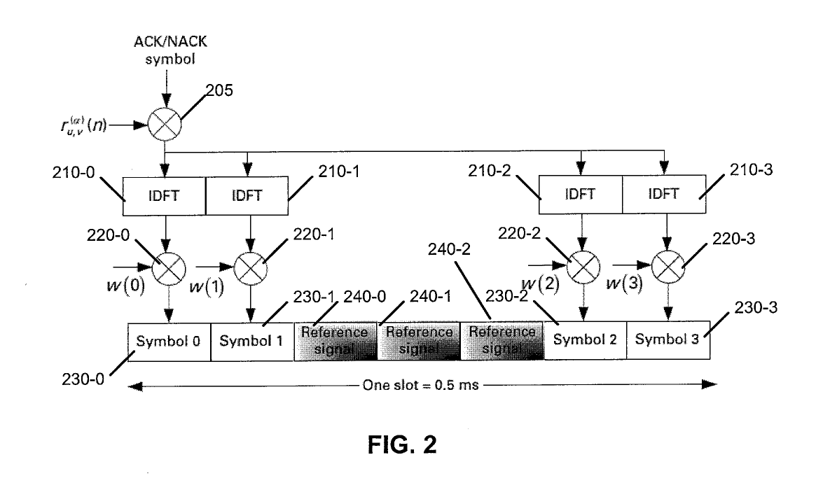

Regarding ACK/NACK transmission in LTE, the transmission of ACK/NACK in one slot can be illustrated in FIG. 2, where the modulated ACK/NACK symbol shall be multiplexed (by multiplier 205) with a cyclically shifted sequence r_{u,v}^{(α)}(n), which is a computer-generated constant amplitude zero auto-correlation (CAZAC) sequence. This sequence is defined by a cyclic shift a of a basic sequence. As illustrated in FIG. 2, the output of the multiplier 205 is passed though IDFTs 210-0, 210-1, 210-2 and 210-3, and the outputs of the IDFTs 210-0 through 210-4 are multiplied by w(0), w(1), w(2), w(3), respectively, which become symbols 230-0, 230-1, 230-2, and 230-3, respectively, in the slot. Reference signals 240-0, 240-1, and 240-2 are also shown. As one configuration, 18 ACK/NACK can be transmitted in one slot with each one mapping to one of three sequences in the time domain (for each of w(0), w(1), w(2), w(3), yielding a total of 12 sequences) and six sequences in the frequency domain (for r_{u,v}^{(α)}(n)).

According to RAN1#81 chairman notes, it has been agreed that MTC SIB indicates at least two PUCCH narrow band regions for coverage enhanced MTC UEs. One problem is that, from the perspective of the UE, it is unclear from which PUCCH region the UE would start the PUCCH transmission, and/or from which PUCCH region the UE would transmit PUCCH for each repeated subframe.

That is, there are no clear proposals from RAN1 contributions on how to decide the PUCCH region to start the PUCCH transmission and/or how to decide the PUCCH region for each repeated subframe. One typical solution is that the UE always selects the lowest (or highest) PUCCH region in frequency domain as the starting region.

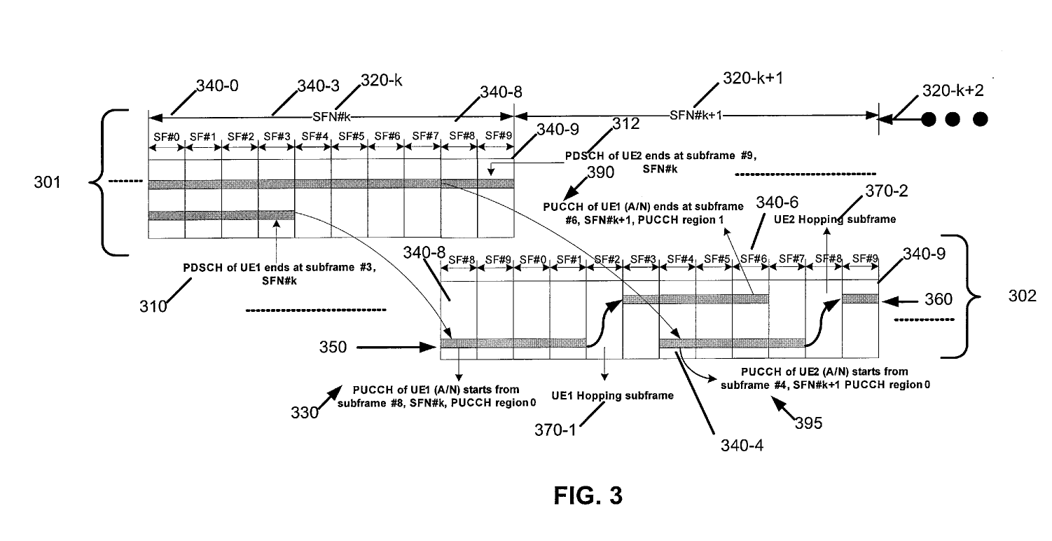

One example is shown in FIG. 3, where the downlink is illustrated by reference 301, where the uplink is illustrated by reference 302, and where the PDSCH 310 for UE1 110-1 is repeated in multiple subframes and is ended at subframe #3, of SFN #k 320-k. Supposing the ACK/NACK would be transmitted after 4ms of the corresponding PDSCH 310 and the PUCCH transmission lasts 8 subframes and there would be hopping once per 4 subframes, then PUCCH carrying ACK/NACK (A/N) for UE1 110-1 is started from subframe#8 340-8 in SFN #k 320-k in PUCCH region 0 350, and PUCCH for UE1 repeats four subframes, then UE1 would retune to PUCCH region 1 360 to continue the transmission until subframe #6 (see reference 390) in SFN #k+1 320-k+1. The same operation is conducted for UE2, where the PDSCH 312 for UE2 110-2 is repeated in multiple subframes and ended at subframe #9 340-9, of SFN #k 320-k. Supposing the ACK/NACK (A/N) would be transmitted after 4 ms of the corresponding PDSCH 312, then PUCCH carrying ACK/NACK for UE1 110-1 is started (see reference 395) from subframe#4 340-4 in SFN #k 320-k in PUCCH region 0 350, and PUCCH for UE2 repeats four subframes, then UE2 would retune to PUCCH region 1 360 to continue the transmission until subframe #63 340-3 (not shown) in SFN #k+2 320-k+2. Here one subframe 370-1, 370-2 is used for PUCCH hopping for the UE1 and UE2, respectively.

It can be observed that both PUCCH regions 350, 360 are occupied from subframe #4 340-4 to subframe #6 340-6 in SFN#k+1. This does not fully take advantage of multiplexing capacity of PUCCH for ACK/NACK transmission, where typically up to 18 ACK/NACK sequences (with CDM) can be multiplexed in one PUCCH region in one subframe, as described above in reference to FIG. 2. That is also to say, this kind of scheme will result in comparatively larger PUCCH overhead, compared with a scheme that can achieve only one PUCCH region occupied at any subframe.

The exemplary embodiments herein target to solve this issue. Furthermore, some exemplary embodiments try to reduce the PUCCH overhead as much as possible.

In particular, one example of a proposal is that a unified PUCCH transmission structure is used for PUCCH transmission for MTC UEs. In each subframe, there is only one PUCCH region used for PUCCH transmission. This means that the available subframes for PUCCH transmission in each PUCCH region are non-overlapping.

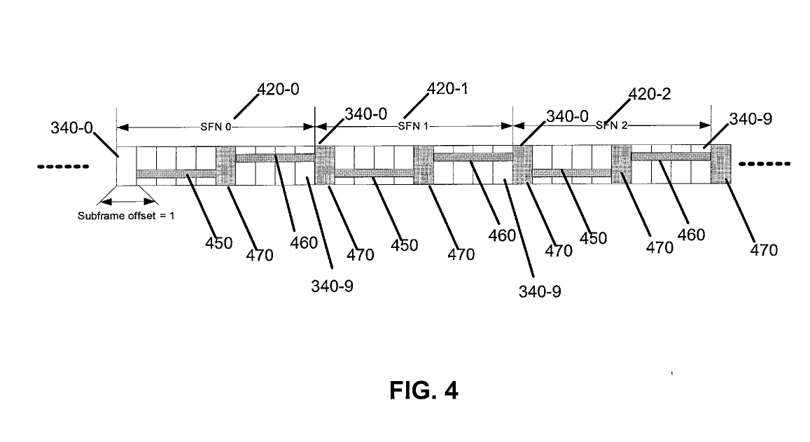

One example is shown in FIG. 4, where two PUCCH narrow band regions 450, 460 are configured for MTC UEs. As is known, LTE Rel. 13 MTC UEs support only 1.4 MHz RF bandwidth regardless of system bandwidth (which can be, e.g., 10 MHz, 20 MHz). Therefore the frequency region allocated for MTC from the system bandwidth is referred to as narrow band. PUCCH region 450 is PUCCH region 0, and PUCCH region 460 is PUCCH region 1. Each frame 420-0, 420-1, and 420-2 includes 10 subframes 340-0 through 340-9. Based on eNB configuration, four subframes (e.g., subframes 340-1 through 340-4 and 340-6 through 340-9) per PUCCH region are used for PUCCH transmissions, and the transmissions alternate between regions 450, 460. It can be seen that only one single PUCCH region (either PUCCH region 0 450 or PUCCH region 1 460) per subframe 340 is allocated (e.g., by an eNB) and used for transmission by MTC UEs of uplink control information. One subframe 470 between PUCCH transmissions is assumed for frequency hopping. In all exemplary embodiments, uplink control information or PUCCH transmission may include for example HARQ-ACK, scheduling request and channel quality information.

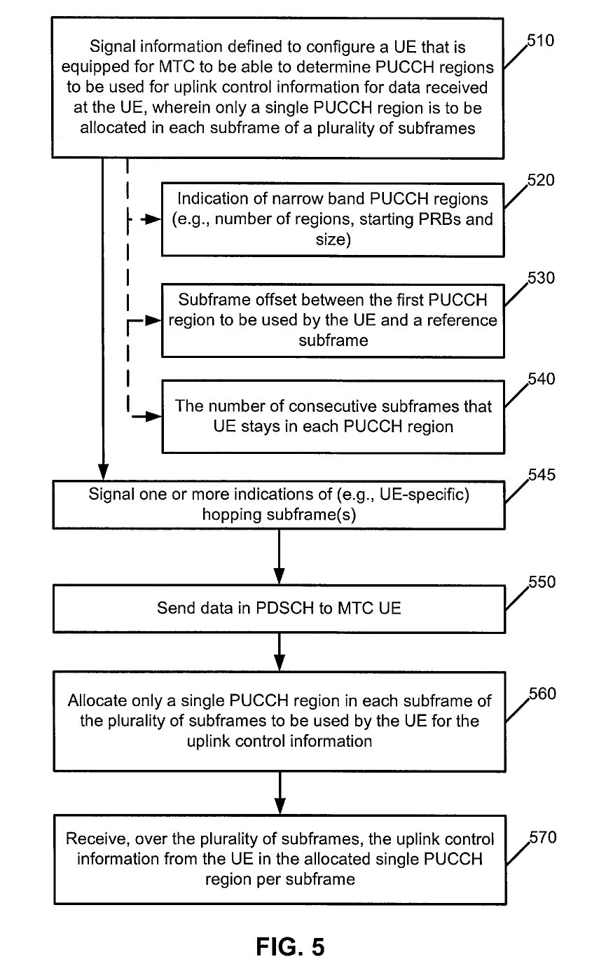

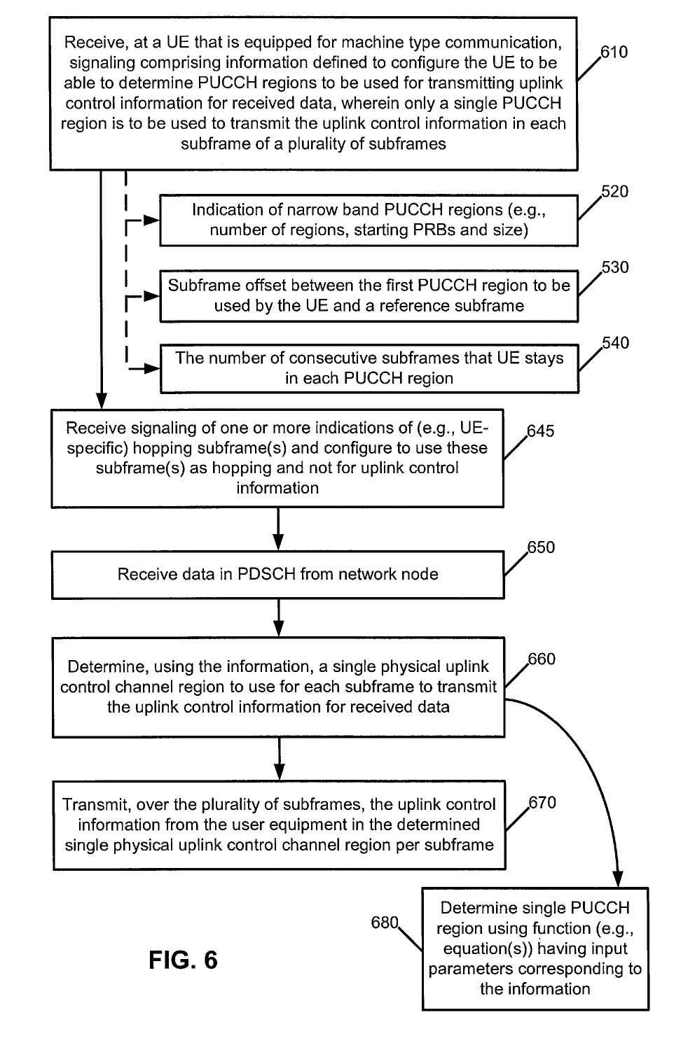

Turning now to FIG. 5, this figure is a logic flow diagram performed by a network node for PUCCH region determination and usage for MTC. This figure also illustrates the operation of an exemplary method, a result of execution of computer program instructions embodied on a computer readable memory, functions performed by logic implemented in hardware, and/or interconnected means for performing functions in accordance with exemplary embodiments. In this example, the network node is assumed to be a base station such as eNB 170, e.g., under control in part of the PUCCH MTC control module 150, and reference solely to eNB 170 is made herein. However, other network nodes may be involved in the method. For instance, the network node could be an RRH 195 that performs at least part of the blocks in FIG. 5. Also, it is noted that the arrangement of blocks in this figure (and FIG. 6) is merely exemplary and the blocks may be arranged in other orders. Furthermore, in an example, MTC SIB indication of PUCCH narrowband regions may be the same for all CE levels. Additionally, the PUCCH regions shown herein may be MTC PUCCH regions, and other, legacy PUCCH regions may also exist that are not shown.

Based on the proposed PUCCH transmission structure of FIG. 4, a UE 110 needs to decide the PUCCH region 450, 460 for each PUCCH subframe 340 after a fixed timing of the end of PDSCH decoding. In order to do that, the eNB 170 will send configuration signaling to UEs. More particularly, in block 510, the eNB 170 signals information defined to configure a UE 110 that is equipped for MTC to be able to determine PUCCH regions to be used for uplink control information for data received at the UE 110. Only a single PUCCH region is to be allocated in each subframe of a plurality of subframes. In other words, the PUCCH region for MTC UEs should not overlap per subframe with another PUCCH region. The configuration signaling information may include one or more of the following:
Indication of narrowband PUCCH regions (e.g., number of regions, starting PRBs and/or the number of contained PRBs for each region). See block 520. As another alternative, the eNB 170 can configure the starting PRB and/or the number of contained PRBs for one specific region (e.g., the region with lowest index in the frequency domain) and the UE 110 can determine the starting PRB and/or the number of contained PRBs for other PUCCH regions. As an example, if the index of the starting PRB for the lowest PUCCH region is J, then the starting PRB for the highest PUCCH region would be B-J-K, where B is the system bandwidth based on unit of PRB, and K is the configured number of PRBs for PUCCH region, and is common for all PUCCH regions. Note that a PRB can be considered to be the same as a subframe for these indications, as a PRB typically has seven symbols occupying 0.5 ms (a subframe). That is, the term “PRB” in this paragraph may be replaced by the term “subframe”.
A (e.g., new) signaling which is the subframe offset between the first PUCCH region (PUCCH region 0) and a reference subframe, such as subframe #0 in SFN#0 (as shown in FIG. 4). See block 530.
The number of consecutive subframes that UE stays in each region, i.e., value X (e.g., which could including the UE retuning time as in the RAN1 agreement). See block 540. In the example of FIG. 4, X is four (without the retuning time) or five (with the retuning time, where the retuning time is added at the end of the four consecutive subframes).

The configuration may be cell-specific and/or can be sent in the broadcasting signaling (e.g., MTC SIB1), or can be UE-specific and can be sent, e.g., in a random access response message during UE initial accessing the network. Note that a single eNB 170 may have multiple cells. For instance, there could be three cells for a single eNB carrier frequency and associated bandwidth, each cell covering one-third of a 360 degree area so that the single eNB's coverage area covers an approximate oval or circle. Furthermore, each cell can correspond to a single carrier and an eNB may use multiple carriers. So if there are three 120 degree cells per carrier and two carriers, then the eNB has a total of 6 cells.

In block 545, the eNB 170 may signal one or more indications of hopping subframe(s). The hopping subframe(s) will be used by a UE 110 to transition from one PUCCH region to another (e.g., from PUCCH region 0 to 1 or vice versa) and will not be used for that UE for uplink control information. As also described below, the hopping subframes for different UEs 110 may be different.

In block 550, the eNB 170 sends data in PDSCH (e.g., as a machine-type communication) to the MTC UE 110. In block 560, the eNB 170 allocates only a single PUCCH region 450 or 460 in each subframe 340 of the plurality of subframes to be used by the UE for the uplink control information. In block 570, the eNB 170 receives, over the plurality of subframes 340, the uplink control information from the UE 110 in the allocated single PUCCH region 450 or 460 per subframe 340. The uplink control information is typically ACK/NACK information for the data in the PDSCH transmitted by the eNB 170 and received by the UE 110. Note that the communication for block 570 is a “normal” communication (as opposed to a machine-type communication), but possibly using repetition.

In one example, the MTC UE 110 performs operations that “mirror” the operations performed by the network node in FIG. 5. This example is illustrated below by FIG. 6. After the description of FIG. 6, a number of examples of alternatives and other considerations are described.

Referring to FIG. 6, this figure is a logic flow diagram performed by an MTC UE for PUCCH region determination and usage for MTC. This figure also illustrates the operation of an exemplary method, a result of execution of computer program instructions embodied on a computer readable memory, functions performed by logic implemented in hardware, and/or interconnected means for performing functions in accordance with exemplary embodiments. The blocks in FIG. 6 are assumed to be performed by the MTC UE 110, e.g., under control in part of the PUCCH MTC control module 140.

In block 610, the UE 110 (which is an MTC UE and is therefore equipped for machine type communication) receives signaling comprising information defined to configure the UE to be able to determine PUCCH regions to be used for transmitting uplink control information for received data. Only a single PUCCH region 450/460 is to be used to transmit the uplink control information in each subframe 340 of a plurality of subframes 340.

As described above, the configuration signaling information may include one or more of the following:
Indication of narrowband PUCCH regions (e.g. number of regions, starting PRBs and size). See block 520.
A (e.g., new) signaling which is the subframe offset between the first PUCCH region (PUCCH region 0) and a reference subframe, such as subframe #0 in SFN#0 (as shown in FIG. 4). See block 530.
The number of consecutive subframes that UE stays in each region, i.e., value X (e.g., which could including the UE retuning time as in the RAN1 agreement). See block 540. In the example of FIG. 4, X is four (without the retuning time) or five (with the retuning time, where the retuning time is added at the end of the four consecutive subframes).

The configuration may, as indicated above, be cell-specific and can be sent in the broadcasting signaling (e.g., MTC SIB1).

In block 645, the MTC UE 110 receives signaling of one or more indications of (e.g., UE-specific) hopping subframe(s) and configures itself to use these subframe(s) as hopping and not for uplink control information. The hopping subframe(s) may be UE-specific as described below.

In block 650, the MTC UE 110 receives data in PDSCH from the network node. In block 660, the MTC UE 110 determines, using the information, a single physical uplink control channel region to use for each subframe to transmit the uplink control information for received data. The MTC UE 110, in block 670, transmits, over the plurality of subframes, the uplink control information from the user equipment in the determined single physical uplink control channel region per subframe.

A number of examples of alternatives and other considerations are now described. For example, block 660 may be performed as described in block 680, wherein the MTC UE 110 determines a single PUCCH region using a function having input parameters corresponding to the information. The function may be implemented via one or more equations, as described in more detail below. In the examples herein, all of the input parameters correspond to the information, but it could be possible for only some of the input parameters to corresponding to the information (e.g., and the remaining input parameters be defined via other means such as a standard). Also, signaling that is used to communicate the information may take place over multiple communications, e.g., at different times, if desired.

Based on eNB 170 configuration, one alternative (alternative 1) for the UE 110 to determine (blocks 660, 680) the PUCCH region 450 or 460 for each PUCCH subframe 340 is through a function with the following input parameters:
The configured subframe offset between the first PUCCH region (PUCCH region 0) and the reference subframe, such as subframe #0 in SFN#0;
The system frame number of the subframe for PUCCH transmission;
The number of consecutive PUCCH subframes in each region, e.g., the value X;
The subframe index of the subframe for PUCCH transmission; and
The number of configured PUCCH regions.

A specific example for alternative 1 is as follows. For each PUCCH subframe 340, the PUCCH region 460 or 470 is decided according to an equation below (equation 1):

$${I}_{PUCCH\_region} = mod \{ ⌊ \frac{( SFN * 10 - {N}_{offset} ) + {I}_{subframe} + 1}{X + 1} ⌋ , {N}_{PUCCH\_region} \} ,$$

where:

I_{PUCCH}_{_}_{region} is the PUCCH region for each PUCCH subframe 0≤I_{PUCCH}_{_}_{region}≤N_{PUCCH}_{_}_{region}−1;

N_{offset} is the configured subframe offset of PUCCH region 0 relative to subframe#0 in SFN=0, N_{offset}>=0;

SFN_{PUCCH} is the system frame number for each PUCCH subframe;

X is the number of consecutive PUCCH subframes in each region;

I_{subframe} is the index of the subframe for PUCCH transmission: for SFN#0, N_{offset}≤I_{subframe}≤9, and for SFN>0, 0≤I_{subframe}≤9; and

N_{PUCCH}_{_}_{region} is the number of configured PUCCH regions.

Note that “mod” means a modulo operation, which finds the remainder after division of one number by another (sometimes called modulus). In the example of equation 1, the modulo operation is in the form of mod(X, Y), which is equivalent to mod(X/Y). Also, the function └X┘ means floor of X, which means the largest integer less than or equal to X.

Taking the structure in FIG. 4 as an example, we have the following:

SFN_{PUCCH}=2 (in this example);

N_{offset}=1;

X=4; and

N_{PUCCH}_{_}_{region}=2.

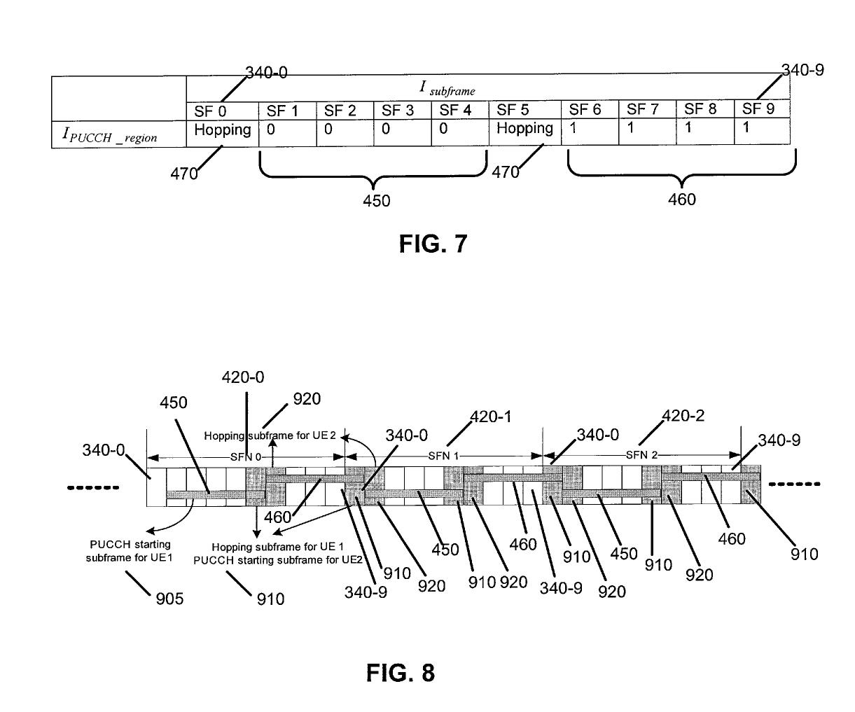

Then according to equation 1, the PUCCH region for each subframe in SFN 2 is as in the table (table 1) in FIG. 7. Consider I_{subframe}=2 (SF 2 in FIG. 7), then:

$${I}_{PUCCH\_region} = mod \{ ⌊ \frac{( 2 * 10 - 1 ) + 2 + 1}{4 + 1} ⌋ , 2 \} ;$$

$${I}_{PUCCH\_region} = mod \{ ⌊ \frac{( 19 ) + 3}{5} ⌋ , 2 \} ;$$

$${I}_{PUCCH\_region} = mod \{ ⌊ \frac{22}{5} ⌋ , 2 \} ;$$

$${I}_{PUCCH\_region} = mod \{ 4 , 2 \} ; and$$

$${I}_{PUCCH\_region} = 0.$$

Consider I_{subframe}=7 (SF 7 in FIG. 7), then:

$${I}_{PUCCH\_region} = mod \{ ⌊ \frac{( 2 * 10 - 1 ) + 7 + 1}{4 + 1} ⌋ , 2 \} ;$$

$${I}_{PUCCH\_region} = mod \{ ⌊ \frac{( 19 ) + 8}{5} ⌋ , 2 \} ;$$

$${I}_{PUCCH\_region} = mod \{ ⌊ \frac{27}{5} ⌋ , 2 \} ;$$

$${I}_{PUCCH\_region} = mod \{ 5 , 2 \} ; and$$

$${I}_{PUCCH\_region} = 1.$$

PUCCH region 0 is illustrated by reference 450, PUCCH region 1 is illustrated by reference 460, and the hopping subframes are illustrated by reference 470. It is noted that the eNB 170 can send configuration as to which subframes are to be hopping subframes (e.g., or whether there are hopping subframes) beforehand.

Another alternative (alternative 2) is that the MTC UE 110 could determine (blocks 660 and 680) the starting PUCCH region and the starting subframe within the starting region. Then according to the value X and the number of repetitions for PUCCH transmission, the MTC UE 110 can determine (blocks 660 and 680) the PUCCH regions for each PUCCH subframe. In this case, the determination of the PUCCH starting region is from the following:
The configured subframe offset between the 1^{st} PUCCH region (PUCCH region 0) and the reference subframe, such as subframe #0 in SFN#0;
The system frame number of the first subframe for PUCCH transmission;
The number of consecutive PUCCH subframes in each region, i.e., the value X;
The subframe index of the first subframe for PUCCH transmission; and
The number of configured PUCCH regions.

The starting subframe index for PUCCH transmission within the PUCCH starting region is an integer value∈[0, X−1]. The decision is implicitly decided by the following:
The configured subframe offset between the 1^{st} PUCCH region (PUCCH region 0) and the reference subframe, such as subframe #0 in SFN#0;
The system frame number of the starting PUCCH subframe;
The subframe index of the first subframe for PUCCH transmission;
The number of consecutive subframes the UE stays in each region, i.e., the value X.

In the following, formulas are provided for alternative 2 on the decision of the PUCCH starting region (equation 2), and the PUCCH starting subframe within the PUCCH starting region (equation 3). Consider equation 2, as follows:

$${I}_{Starting\_PUCCH \_region} = mod \{ ⌊ \frac{\begin{matrix}( {SFN}_{Starting\_PUCCH \_subframe} * 10 - {N}_{offset} ) + \\ {I}_{starting\_subframe} + 1\end{matrix}}{X + 1} ⌋ , {N}_{PUCCH\_region} \}$$

where:

I_{Starting}_{_}_{PUCCH}_{_}_{region} is the starting PUCCH region, 0≤I_{Starting}_{_}_{PUCCH}_{_}_{region}≤N_{PUCCH}_{_}_{region}−1;

N_{offset} is the configured subframe offset of PUCCH region 0 relative to subframe#0 in SFN=0, N_{offset}>=0;

SFN_{Starting}_{_}_{PUCCH}_{_}_{subframe} is the system frame number of the starting PUCCH subframe;

X is the number of consecutive PUCCH subframes in each region;

I_{starting}_{_}_{subframe} is the subframe index of the first subframe for PUCCH transmission: for SFN#0, N_{offset}≤I_{starting}_{_}_{subframe}≤9, and for SFN>0, 0≤I_{starting}_{_}_{subframe}≤9; and

N_{PUCCH}_{_}_{region} is the number of configured PUCCH regions.

The starting subframe for PUCCH transmission within the starting PUCCH region is decided by the equation (equation 3) below:

I′_{Starting}_{_}_{PUCCH}_{_}_{subframe}=mod{[(SFN_{Starting}_{_}_{PUCCH}_{_}_{subframe}*10−N_{offset})+I_{starting}_{_}_{subframe}], X},

where:

I′_{Starting}_{_}_{PUCCH}_{_}_{subframe} is the starting subframe within the starting subframe region, 0≤I′_{Starting}_{_}_{PUCCH}_{_}_{subframe}≤X−1;

N_{offset} is the configured subframe offset of PUCCH region 0 relative to subframe#0 in SFN=0;

SFN_{Starting}_{_}_{PUCCH}_{_}_{subframe} is the system frame number of the starting PUCCH subframe;

I_{starting}_{_}_{subframe} is the subframe index of the first subframe for PUCCH transmission: for SFN#0, N_{offset}≤I_{subframe}≤9, and for SFN>0, 0≤I_{subframe}≤9; and

X is the number of consecutive PUCCH subframes in each region.

Then the number of subframes in the starting PUCCH region for PUCCH transmission is X−I′_{Starting}_{_}_{PUCCH}_{_}_{subframe}.

Still taking the example shown in FIG. 4, which is an illustration of use of only one PUCCH region in each subframe in accordance with an exemplary embodiment, we have the following:

SFN_{Starting}_{_}_{PUCCH}_{_}_{subframe}=2 (in this example);

N_{offset}=1;

X=4; and

N_{PUCCH}_{_}_{region}=2.

Consider I_{starting}_{_}_{subframe}=2, then according to equation 2, the starting region PUCCH region is:

$${I}_{Starting\_PUCCH \_region} = mod \{ ⌊ \frac{( 2 * 10 - 1 ) + 2 + 1}{4 + 1} ⌋ , 2 \} = 0.$$

According to equation 3, the starting subframe within the starting region is

I′_{Starting}_{_}_{PUCCH}_{_}_{subframe}=mod{[(2*10−1)+2], 4}=1.

An additional consideration is how to avoid PUCCH transmission in a hopping subframe. For example, given the structure in FIG. 4, where the hopping subframes 470 happen in fixed positions for all MTC UEs 110, it might happen that the first PUCCH subframe is the hopping subframe. To avoid the UE's transmitting PUCCH in the hopping subframe 470, one solution would be that if the PUCCH region for second PUCCH subframe is different than that for the first PUCCH subframe, the UE will not transmit PUCCH in the first PUCCH subframe.

Another option is that the UE will transmit PUCCH anyway in the first PUCCH subframe, if the PUCCH region of the second PUCCH subframe is different than that for the first PUCCH subframe, the second PUCCH subframe is used for hopping. This means that one may introduce a UE-specific hopping subframe. One example is shown in FIG. 8, where UE1 and UE2 are configured with 2 PUCCH regions and the PUCCH would repeat 8 subframes, then the following is used:
For UE1 110-1, the PUCCH starting subframe (see reference 905) is subframe #2 340-2 in the SFN #0 420-0 and the hopping subframe (see reference 910) is subframe #5 340-5 in the SFN #0 420-0, and UE1 uses subframes #1 340-1 through #4 340-4 and #6 340-6 through #9 340-9 in SFN #0 and subframe #1 in SFN#1; and
For UE2 110-2, the PUCCH starting subframe (see reference 910) is subframe #5 340-5 in the SFN #0 420-0 and the hopping subframe (see reference 920) is subframe #6 340-6 in the SFN #0 420-0, and UE2 uses subframes #5 340-5 and #7 340-7 through #9 340-9 in SFN #0 and subframe #2 through #4 in SFN#1.

It is noted that CDM is being used in FIG. 8, as both UE1 and UE2 use the PUCCH region 1 460. For CDM, each UE can be explicitly assigned a different code, or the different codes can be decided implicitly by, e.g., the index of the end subframe of PDSCH or the new time domain CCE index.

Without in any way limiting the scope, interpretation, or application of the claims appearing below, a technical effect of one or more of the example embodiments disclosed herein is reduced PUCCH overhead, as the eNB only allocates single PUCCH regions in each subframe, and the PUCCH from different UEs may be multiplexed in one region using CDM. Therefore compared with previous techniques, the PUCCH overhead is much reduced. Another technical effect of one or more of the example embodiments disclosed herein is to enable MTC UEs to determine which signal PUCCH region to use for transmission of uplink control data. Another technical effect of one or more of the example embodiments disclosed herein is use of a unified PUCCH transmission structure for PUCCH transmission for MTC UEs. A further technical effect is that the available subframes for PUCCH transmission in each PUCCH region are non-overlapping.

Embodiments of the present invention may be implemented in software (executed by one or more processors), hardware (e.g., an application specific integrated circuit), or a combination of software and hardware. In an example embodiment, the software (e.g., application logic, an instruction set) is maintained on any one of various conventional computer-readable media. In the context of this document, a “computer-readable medium” may be any media or means that can contain, store, communicate, propagate or transport the instructions for use by or in connection with an instruction execution system, apparatus, or device, such as a computer, with one example of a computer described and depicted, e.g., in FIG. 1. A computer-readable medium may comprise a computer-readable storage medium (e.g., memory 125, 155 or other device) that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims. 3GPP third generation partnership project

ACK acknowledge

A/N ACK/NACK

BW bandwidth

CAZAC constant amplitude zero auto-correlation

CDM code division multiplexing

CE coverage enhancement

CSI channel state information

DCI downlink control information

DFT discrete Fourier transform

DL downlink

eNB or eNodeB base station, evolved Node B

MPDCCH MTC physical downlink control channel

FDD frequency division duplexing

FFS for future study

HARQ hybrid automatic repeat request

IDFT inverse DFT

LTE long term evolution

ms milliseconds

MPDCCH MTC-capable PDCCH

MTC machine type communication

NACK negative acknowledge

NCE network control element

PDCCH physical downlink control channel

PDSCH physical downlink sharing channel

PLMN public land mobile network

PRB physical resource block

PUCCH physical uplink control channel

RAN1 radio layer working group 1

Rel release

RF radio frequency

RRH remote radio head

SF subframe

SFN system frame number

SGW serving gateway

SIB system information block

SR scheduling request

TDM time division multiplexing

TS technical specification

UE user equipment

UL uplink

1-25. (canceled)

26. An apparatus, comprising:
one or more processors; and
one or more memories including computer program code, the one or more memories and the computer program code are configured to, with the one or more processors, cause the apparatus to:
receive, at a user equipment that is equipped for machine type communication, signaling comprising information defined to configure the user equipment to be able to determine physical uplink control channel regions to be used for transmitting uplink control information for received data, wherein only a single physical uplink control channel region is to be used to transmit the uplink control information in each subframe of a plurality of subframes;
determine, using the signaled information, a single physical uplink control channel region to use for each subframe to transmit the uplink control information for received data; and
transmit, over the plurality of subframes, the uplink control information from the user equipment in the determined single physical uplink control channel region per subframe.

27. The apparatus of claim 26, wherein the signaled information enables the user equipment to determine one of a plurality of configured physical uplink channel control channel regions to use for each of the subframes for one or more frames.

28. The apparatus of claim 27, wherein the information comprises one or more of the following:
a configured subframe offset between the configured first physical uplink control channel region and a reference subframe;
a system frame number of a subframe for a physical uplink control channel transmission;
a number of consecutive physical control channel subframes in each configured physical uplink control channel region;
a subframe index of a subframe for the physical uplink control channel transmission; or
a number of the configured physical uplink control channel regions.

29. The apparatus of claim 27, wherein the signaled information comprises a starting subframe for the one configured physical uplink channel control channel region and/or a number of subframes to be used for the one specific physical uplink channel control channel region, and wherein the user equipment is expected to determine a starting subframe and/or a number of subframes to be used for other ones of the configured physical uplink control channel regions.

30. The apparatus according to claim 26, wherein configuration based on the signaled information is specific to a cell or is specific to a single user equipment.

31. The apparatus according to claim 26, wherein the signaling comprises broadcasting signaling received in a system information block in response to the information being cell-specific, or the signaling is received in a random access response message during initial access of a network by the user equipment in response to the information being user equipment-specific.

32. The apparatus according to claim 26, wherein the signaled information enables the user equipment to determine a starting region of a plurality of configured physical uplink channel control channel regions to use for each of the subframes for a frame and also to determine a starting subframe within the starting region.

33. The apparatus according to claim 32, wherein the signaled information comprises one or more of the following:
a configured subframe offset between the configured first physical uplink control channel region and a reference subframe,
a system frame number of a first subframe for a physical uplink control channel transmission;
a number of consecutive physical control channel subframes in each configured physical uplink control channel region;
a subframe index of the first subframe for physical uplink control channel transmission; or
a number of the configured physical uplink control channel regions.

34. The apparatus according to claim 26, wherein the signaled information also comprises one or more indications of subframes to be used for hopping and not for uplink control information for the user equipment.

35. An apparatus, comprising:
one or more processors; and
one or more memories including computer program code, the one or more memories and the computer program code are configured to, with the one or more processors, cause the apparatus to:
allocate only a single physical uplink control channel region in each subframe of a plurality of subframes to be used by one or more user equipments for uplink control information transmission;
signal information defined to configure a user equipment that is equipped for machine type communication to be able to determine physical uplink control channel regions to be used for uplink control information transmission for data received at the user equipment; and
receive, over the plurality of subframes, the uplink control information from the user equipment in the single physical uplink control channel region per subframe.

36. The apparatus of claim 35, wherein the signaled information enables the user equipment to determine one of a plurality of configured physical uplink channel control channel regions to use for each of the subframes for one or more frames.

37. The apparatus of claim 36, wherein the information comprises one or more of the following:
a configured subframe offset between the configured first physical uplink control channel region and a reference subframe;
a system frame number of a subframe for a physical uplink control channel transmission;
a number of consecutive physical control channel subframes in each configured physical uplink control channel region;
a subframe index of a subframe for the physical uplink control channel transmission; or
a number of the configured physical uplink control channel regions.

38. The apparatus of claim 36, wherein the signaled information comprises a starting subframe for the one configured physical uplink channel control channel region and/or a number of subframes to be used for the one specific physical uplink channel control channel region, and wherein the user equipment is expected to determine a starting subframe and/or a number of subframes to be used for other ones of the configured physical uplink control channel regions.

39. The apparatus of claim 35, wherein configuration based on the signaled information is specific to a cell or is specific to a single user equipment.

40. The apparatus of claim 35, wherein the signaling uses broadcasting signaling in a system information block in response to the information being cell-specific, or the signaling is sent in a random access response message during initial access of a network by the user equipment in response to the information being user equipment-specific.

41. The apparatus of claim 35, wherein the signaled information enables the user equipment to determine a starting region of a plurality of configured physical uplink channel control channel regions to use for each of the subframes for a frame and also to determine a starting subframe within the starting region.

42. The apparatus of claim 41, wherein the signaled information comprises one or more of the following:
a configured subframe offset between the configured first physical uplink control channel region and a reference subframe;
a system frame number of a first subframe for a physical uplink control channel transmission;
a number of consecutive physical control channel subframes in each configured physical uplink control channel region;
a subframe index of the first subframe for physical uplink control channel transmission; or
a number of the configured physical uplink control channel regions.

43. The apparatus of claim 35, wherein:
the signaling information is performed for first and second user equipments, and wherein the signaling information for the first and second user equipments is defined so that both the first and second user equipments use at least one same subframe in at least one same physical uplink control channel region to send uplink control information; and
receiving further comprises receiving the uplink control information from the first and second user equipments in the at least one same subframe in the at least one same physical uplink control channel region.

44. A method, comprising:
allocating only a single physical uplink control channel region in each subframe of a plurality of subframes to be used by one or more user equipments for uplink control information transmission;
signaling information defined to configure a user equipment that is equipped for machine type communication to be able to determine physical uplink control channel regions to be used for uplink control information transmission for data received at the user equipment; and
receiving, over the plurality of subframes, the uplink control information from the user equipment in the single physical uplink control channel region per subframe.

45. A method, comprising:
receiving, at a user equipment that is equipped for machine type communication, signaling comprising information defined to configure the user equipment to be able to determine physical uplink control channel regions to be used for transmitting uplink control information for received data, wherein only a single physical uplink control channel region is to be used to transmit the uplink control information in each subframe of a plurality of subframes;
determining, using the signaled information, a single physical uplink control channel region to use for each subframe to transmit the uplink control information for received data; and
transmitting, over the plurality of subframes, the uplink control information from the user equipment in the determined single physical uplink control channel region per subframe.
